(19) United States
(12) Patent Application Publication
(10) Pub. No.: US 2019/0082469 A1
(43) Pub. Date: Mar. 14, 2019

(54) USER EQUIPMENT AND COMMUNICATION METHOD

(71) Applicant: NTT DOCOMO, INC., Tokyo (JP)

(72) Inventors: Yousuke Sano, Tokyo (JP); Kazuaki Takeda, Tokyo (JP); Satoshi Nagata, Tokyo (JP)

(73) Assignee: NTT DOCOMO, INC., Tokyo (JP)

(21) Appl. No.: 16/088,643

(22) PCT Filed: Feb. 3, 2017
(86) PCT No.: PCT/JP2017/004053

§ 371 Date: Sep. 26, 2018

(30) Foreign Application Priority Data
Mar. 31, 2016 (JP) 2016-073460

(51) Int. Cl. H04W 74/08; H04W 56/00; H04W 4/70

(52) U.S. Cl. CPC H04W 74/0833; H04W 74/0866; H04W 88/02; H04W 4/70; H04W 56/001

(57) ABSTRACT

A user equipment that is provided in a wireless communication system including a base station and the user equipment includes a selection unit that selects one access method from a plurality of access methods used when uplink communications start and a communication unit that transmits an uplink signal to the base station according to a procedure defined by the selected access method.

### TECHNICAL FIELD

The present invention relates to a user equipment and a communication method.

### BACKGROUND ART

In a long term evolution (LTE) standard, a next-generation wireless communication system which is called a 5G communication system has been discussed in order to further increase system capacity and a data transmission rate and to further reduce a delay in a wireless section.

In the 5G communication system, various element techniques have been discussed in order to satisfy the requirements that a delay in the wireless section is reduced to 1 ms or less while a throughput of 10 Gbps or more is obtained. In addition, an underlying technique that enables a large number of machine-type communication (MCT) terminals to transmit data through a 5G wireless network has been discussed in order to respond to a service typified by the Internet of things (IoT). A technique that enables a large number of MTC terminals to access a network is called massive machine-type-communications (mMTC) in the 5G communication system.

### CITATION LIST

### Non-Patent Document

Non-Patent Document 1: 3GPP TR38.913 V0.2.0 (2016-02)
Non-Patent Document 2: 3GPP TS36.300 V13.2.0 (2015-12)

### SUMMARY OF THE INVENTION

### Problem to be Solved by the Invention

Here, when a large number of MTC terminals access the network, there is a concern that the number of signaling messages (control signals) which are transmitted to and received from the network will increase significantly. For example, the LTE system according to the related art adopts an access method in which a base station controls the entire uplink (UL) communication using a random access procedure (RA procedure). If a large number of MTC terminals access the network, the number of signaling messages used in the RA procedure increases significantly.

Therefore, the following access method is considered in order to reduce the number of signaling messages: a base station does not control the entire UL communication and allows UL signal contention between the MTC terminals to reduce the number of signaling messages. It is considered that the use of the access method makes it possible to reduce the number of signaling messages even when a large number of MTC terminals access the network.

It is assumed that the amount of traffic over time varies depending on the purpose of the MTC terminal. For example, a situation in which a large number of MTC terminals simultaneously transmit data as illustrated in FIG. 1 is assumed. When the access method that allows UL signal contention between the MTC terminals is used in this situation, UL signals which are transmitted from each MTC terminal interfere with each other. As a result, there is possibility that the UL signals will not reach the base station. This problem is not limited to the MTC terminals and may occur in any other types of terminals that access the network.

When this situation is considered, it is considered that a structure which can adaptively change various access methods according to the number of terminals and the amount of traffic is required. However, in particular, in a 3GPP uplink protocol, there is no technique that can adaptively change various access methods.

The disclosed technique has been made in view of the above-mentioned problems and an object of the disclosed technique is to provide a technique that can adaptively change various access methods.

### Means for Solving Problem

A user equipment according to the disclosed technique is provided in a wireless communication system including a base station and the user equipment and includes a selection unit that selects one access method from a plurality of access methods used when uplink communications start and a communication unit that transmits an uplink signal to the base station according to a procedure defined by the selected access method.

### Effect of the Invention

According to the disclosed technique, a technique that can adaptively change various access methods is provided.

### BRIEF DESCRIPTION OF DRAWINGS

FIG. 1 is a diagram illustrating a bias in traffic;

FIG. 2 is a diagram illustrating an example of the structure of a wireless communication system according to an embodiment;

FIG. 3 is a diagram illustrating a random access procedure (RA procedure) defined in LTE;

FIG. 4 is a diagram illustrating an example of an access method used in the embodiment;

FIG. 5 is a sequence diagram illustrating the procedure of access method selection method 1-1;

FIG. 6A is a diagram illustrating an example of access method instruction information;

FIG. 6B is a diagram illustrating an example of access method instruction information;

FIG. 6C is a diagram illustrating an example of access method instruction information;

FIG. 7 is a sequence diagram illustrating the procedure of access method selection method 1-3;

FIG. 8A is a diagram illustrating an example of group information and access method instruction information;

FIG. 8B is a diagram illustrating an example of group information and access method instruction information;

FIG. 9 is a diagram illustrating an example of the operation of the wireless communication system when access method selection method 1-3 is used;

FIG. 10 is a sequence diagram illustrating the procedure of access method selection method 2-1;

FIG. 11 is a sequence diagram illustrating the procedure of access method selection method 2-2;

FIG. 12A is a diagram illustrating an example of a radio resource allocation method;

FIG. 12B is a diagram illustrating an example of a radio resource allocation method;

FIG. 13A is a diagram illustrating an example of group information and access method instruction information;

FIG. 13B is a diagram illustrating an example of group information and access method instruction information;

FIG. 14 is a diagram illustrating an example of the functional structure of a user equipment according to the embodiment;

FIG. 15 is a diagram illustrating an example of the functional structure of a base station according to the embodiment;

FIG. 16 is a diagram illustrating an example of the hardware configuration of the user equipment according to the embodiment; and

FIG. 17 is a diagram illustrating an example of the hardware configuration of the base station according to the embodiment.

### MODE(S) FOR CARRYING OUT THE INVENTION

Hereinafter, an embodiment of the invention will be described with reference to the drawings. The following embodiment is illustrative and the embodiment to which the invention is applied is not limited to the following embodiment. For example, it is assumed that a wireless communication system according to this embodiment is a system based on LTE (including 5G). However, the invention is not limited to LTE (including 5G) and can be applied to other communication systems. In the specification and the claims, “LTE” includes a fifth-generation communication system corresponding to 3GPP Release 10, 11, 12, 13, 14, or beyond, in addition to a communication system corresponding to 3GPP Release 8 or 9.

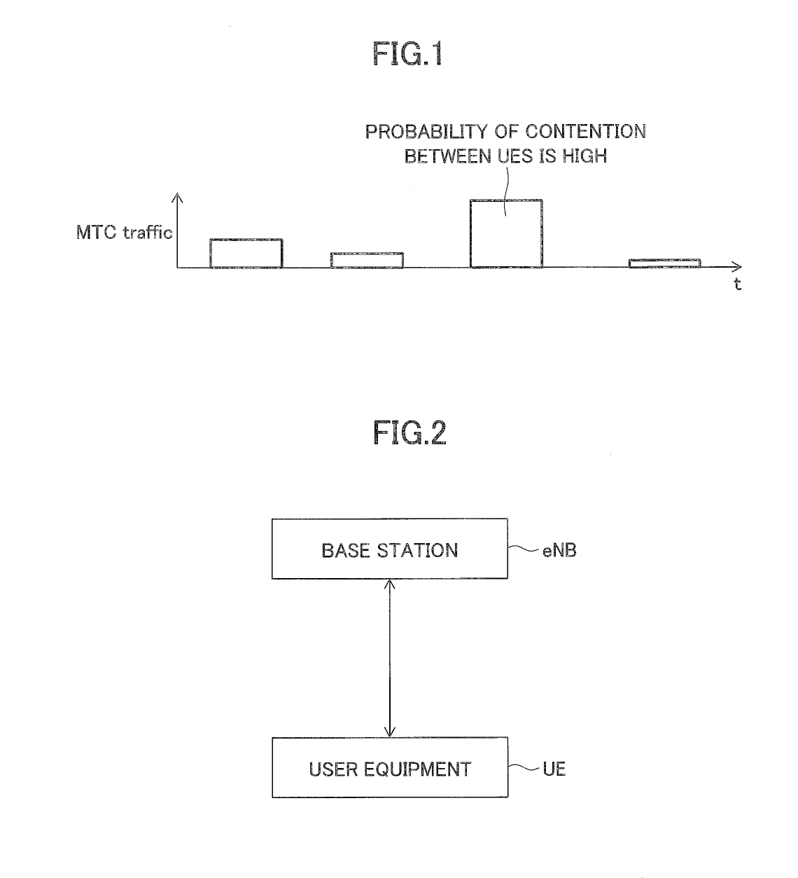

FIG. 2 is a diagram illustrating an example of the structure of a wireless communication system according to this embodiment. As illustrated in FIG. 2, the wireless communication system according to this embodiment includes a base station eNB and a user equipment UE. In the example illustrated in FIG. 2, one base station eNB and one user equipment UE are illustrated. However, the wireless communication system may include a plurality of base stations eNB or a plurality of user equipments UE.

<For RA Procedure in LTE>

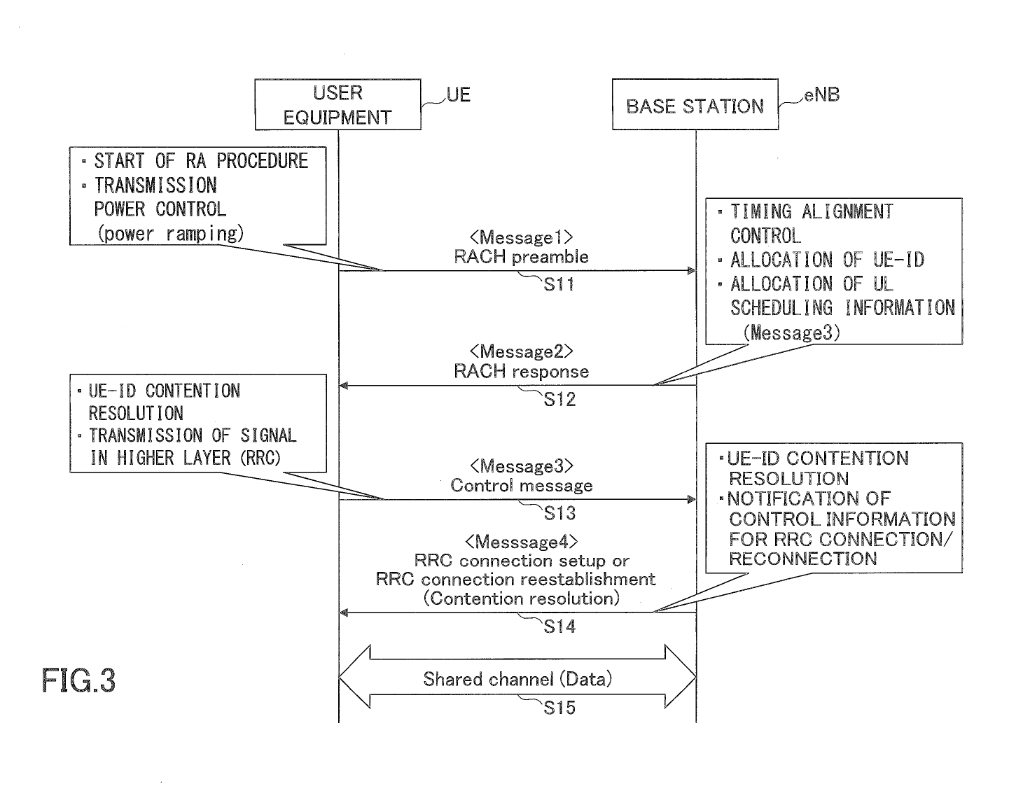

Here, a random access procedure (RA procedure) which is defined in the LTE standard will be described with reference to FIG. 3. Before the RA procedure starts, the user equipment UE receives a synchronizing signal transmitted from the base station eNB and performs radio frame synchronization (including symbol timing synchronization). In addition, the user equipment UE receives broadcast information (a master information block (MIB) and a system information block (SIB)) and acquires various kinds of information related to a system bandwidth, a system frame number (SFN), and cells and various kinds of information for performing the RA procedure.

First, the user equipment UE selects an arbitrary RA preamble from a plurality of RA preamble candidates and transmits the selected RA preamble (also referred to as a RACH preamble) to the base station eNB (S11). A message for transmitting the RA preamble is referred to as Message1 and is used by the user equipment UE to start the RA procedure. Then, the base station eNB detects the RA preamble transmitted from the user equipment UE and transmits an RACH response to the user equipment UE (S12). The RACH response is referred to as Message2 and includes the detected RA preamble, temporary UE-ID (temporary cell radio network temporary identifier (temporary C-RNTI)), timing alignment control information (transmission timing information), and uplink (UL) scheduling information (UL grant for transmitting Message3).

Then, the user equipment UE transmits a control message to the base station 3 according to the transmission timing information included in the RACH response, using radio resources designated by the UL scheduling information in the RACH response (S13). The control message is referred to as Message3 and includes a signal in a higher layer (RRC). In addition, the user equipment UE transmits a control message including a terminal identifier (UE contention resolution identity) to the base station eNB, using the temporary UE-ID included in the RACH response.

Then, the base station eNB receives the control message, using the temporary UE-ID (temporary C-RNTI), and transmits an RRC message (RRC connection setup or RRC connection reestablishment) for RRC connection or RRC reconnection to the user equipment UE (S14). The RRC message is referred to as Message4. Here, the base station eNB inserts the terminal identifier (UE contention resolution identity) included in the control message into the RRC message and transmits the RRC message. When receiving the control messages from a plurality of user equipments UE, the base station eNB selects any one of the control messages transmitted from the user equipments UE, inserts the terminal identifier (UE contention resolution identity) included in the selected control message into the RRC message and transmits the RRC message.

When the terminal identifier which has been inserted into the control message by the user equipment UE is included in the RRC message, the user equipment UE determines that the RA procedure has succeeded. When the terminal identifier is not included in the RRC message, the user equipment UE determines that the RA procedure has failed (the RA procedure has collided with the RA procedure of another user equipment UE).

Then, the user equipment UE which determines that the RA procedure has been successful starts transmitting and receiving data to and from the base station eNB, using a shared channel (S15). The user equipment UE regards the temporary UE-ID as UE-ID (C-RNTI) allocated to the user equipment UE. In contrast, the user equipment UE which determines that the RA procedure has failed increases transmission power used to transmit the RA preamble and performs Step S11 again. This procedure is referred to as transmission power control (rower ramping).

The above-mentioned RA procedure is summarized as follows. As illustrated in FIG. 3, “transmission power control” is performed by Message1, “timing alignment control”, “UE-ID allocation”, and “UL scheduling information allocation” are controlled by Message2, and “UE-ID contention resolution” is controlled by Message3 and Message4.

<For Access Method Used in this Embodiment>

In this embodiment, as an access method that is used to access the network by the user equipment UE, a plurality of access methods with different amounts of signaling and different processing loads are allowed to be used. In addition, it is possible to adaptively change the access methods used by the user equipment UE according to, for example, traffic conditions.

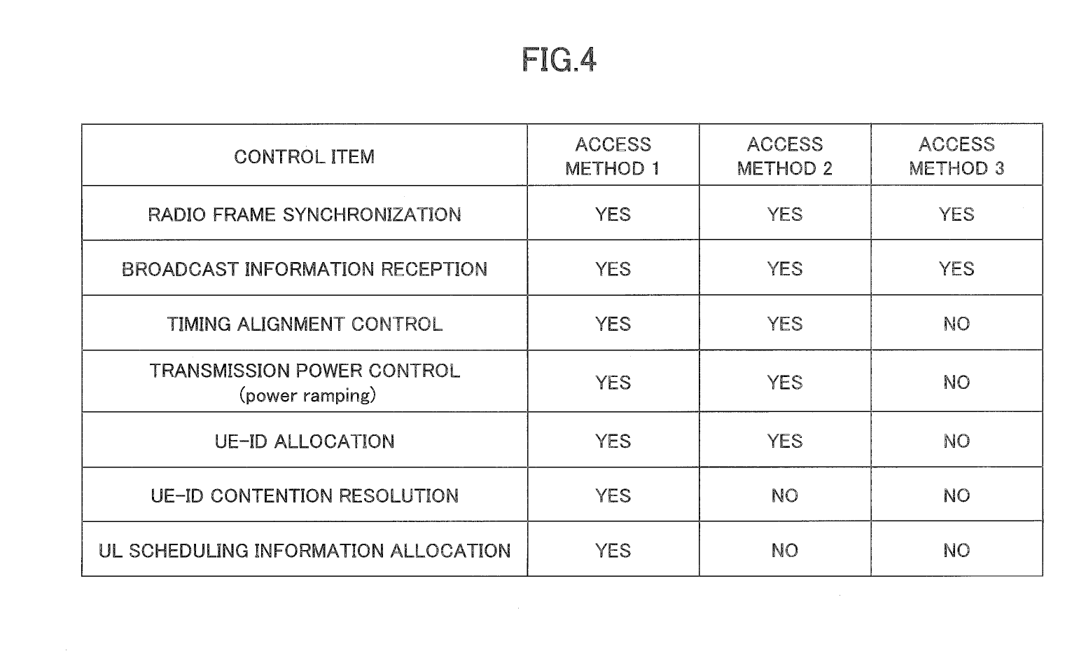

FIG. 4 is a diagram illustrating an example of the access method used in the embodiment. As illustrated in FIG. 4, access method 1 is an access method that supports the control of all of “radio frame synchronization”, “broadcast information reception”, “timing alignment control”, “transmission power control”, “UE-ID allocation”, “UE-ID contention resolution”, and “UL scheduling information allocation”. In access method 1, it is assumed that the same signaling messages (that is, messages corresponding to Message1 to Message4) as those in the RA procedure in LTE are used. Access method 1 has the advantages that the base station eNB can control the entire UL communication and, when the signaling message (a message corresponding to Message3 in LTE) used in access method 1 is decoded, the base station eNB decodes only the radio resources which have been allocated by the base station eNB using UL scheduling information.

Access method 2 is an access method that supports the control of “radio frame synchronization”, “broadcast information reception”, “timing alignment control”, “transmission power control”, and “UE-ID allocation”. In access method 2, it is assumed that only the signaling messages corresponding to Message1 and Message2 in the RA procedure in LTE are used. Access method 2 has the advantage that it does not support the control of “UE-ID contention resolution” and “UL scheduling information allocation” and can reduce the amount of signaling.

Access method 3 is an access method that supports only the control of “radio frame synchronization” and “broadcast information reception” and can directly transmit data to the network, without using the signaling messages corresponding to Message1 to Message4 in the RA procedure in LTE (in the example illustrated in FIG. 3, only Step S15 is performed). Access method 3 has the advantage that it does not support the functions of “timing alignment control”, “transmission power control”, “UE-ID allocation”, “UE-ID contention resolution”, and “UL scheduling information allocation” and can further reduce the amount of signaling, as compared to access method 2.

The above-mentioned access methods 1 to 3 are illustrative and the invention is not limited thereto. In this embodiment, it is possible to support various access methods that have different numbers of signaling messages or support different functions. In addition, the number of access methods to be supported is not limited. For example, in this embodiment, only two types of access methods may be supported or four or more types of access methods may be supported.

<For Method for Selecting Access Method>

Next, a method for selecting an access method used when the user equipment UE that has not established a radio link to the base station eNB starts transmitting and receiving data to and from the base station eNB will be described in detail.

(Selection Method 1-1)

In selection method 1-1, the user equipment UE communicates with the base station eNB, using one access method among one or more access methods indicated by the base station eNB.

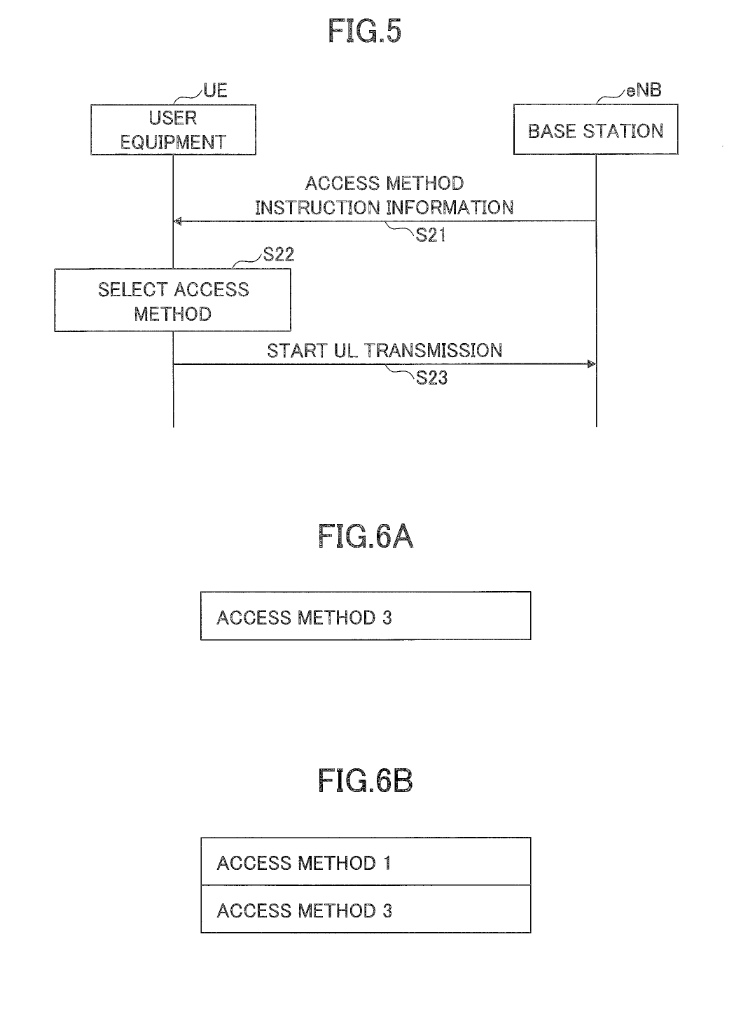

FIG. 5 is a sequence diagram illustrating the procedure of access method selection method 1-1. The base station eNB transmits access method instruction information indicating the access method to be used by the user equipment UE to the user equipment UE (S21). The base station eNB may broadcast the access method instruction information to the user equipments UE in a cell, using broadcast information, or may transmit, to the individual user equipment UE, the access method instruction information, using the signaling message (for example, an RRC message or downlink control information (DCI)) of the individual user equipment UE which is used in a control channel. Then, the user equipment UE selects an access method according to the access method instruction information (S22) and starts the transmission of a UL signal, using the selected access method (S23).

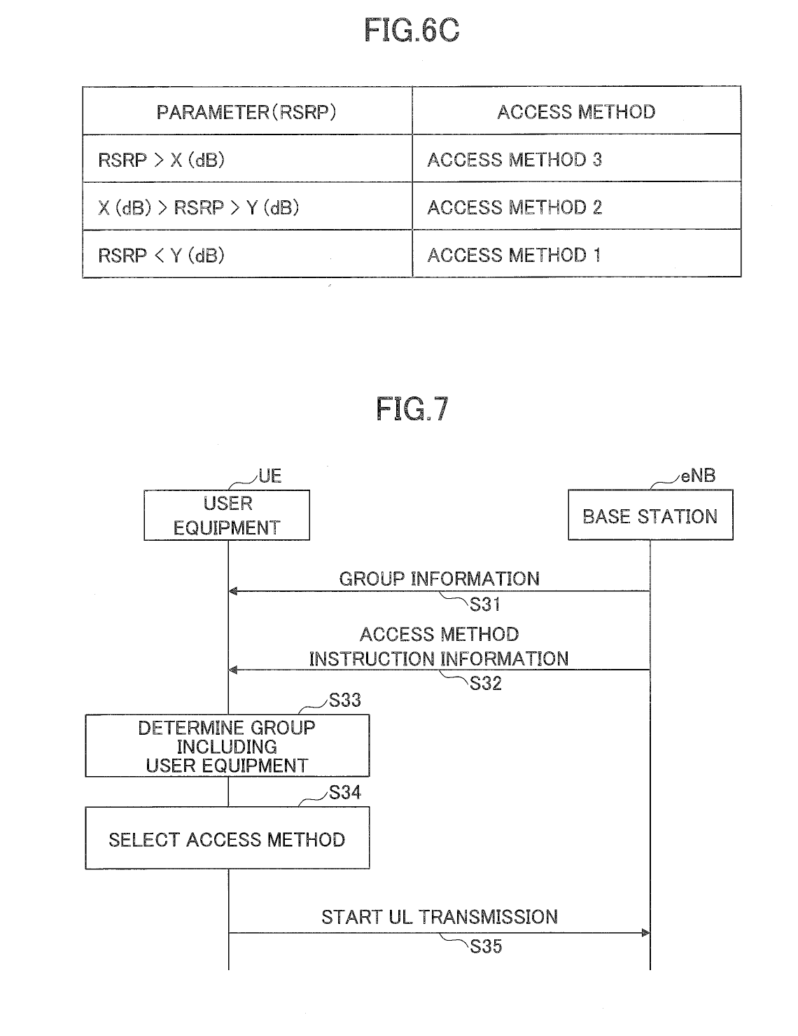

FIG. 6A illustrates an example of the access method instruction information including only a specific access method. The base station eNB can direct the user equipment UE to perform only a specific access method, using the access method instruction information illustrated in FIG. 6A. FIG. 6B illustrates an example of the access method instruction information including a plurality of access methods. In the case of FIG. 6B, the user equipment UE may arbitrarily select one access method among the plurality of access methods included in the access method instruction information or the user equipment UE may select an access method that is supported by (corresponds to) the user equipment UE.

(Selection Method 1-2)

In selection method 1-2, the base station eNB transmits, to the user equipment UE, access method instruction information in which a predetermined parameter and the access method are associated with each other. The user equipment UE compares the access method instruction information with the predetermined parameter recognized (or selected) by the user equipment UE to select one access method and communicates with the base station eNB, using the selected access method.

The predetermined parameter may be any parameter. For example, the predetermined parameter is a receiving signal received poser (RSRP). However, the invention is not limited thereto. The predetermined parameter may be receiving signal received quality (RSRQ), a signal-to-interference plus noise power ratio (SINR), a received signal strength indicator (RSSI), or a signal-to-noise Ratio (SNR). In addition, the predetermined parameter may be a modulation method (for example, QPSK, 16QAM, or 64QAM) or a data size to be transmitted by UL.

FIG. 6C illustrates an example of the access method instruction information in selection method 1-2. FIG. 6C illustrates a case in which RSRP is used as the predetermined parameter. When starting transmitting and receiving data to and from the base station eNB, the user equipment UE measures the RSRP of the radio signal transmitted from the base station eNB. Then, the user equipment UE compares the measured RSRP with the access method instruction information to select an access method associated with the measured RSRP and communicates with the base station eNB, using the selected access method.

(Selection Method 1-3)

Selection method 1-3 groups the user equipments UE according to a predetermined parameter and associates the groups with the access methods. The predetermined parameter is the same as that in selection method 1-2.

FIG. 7 is a sequence diagram illustrating the procedure of access method selection method 1-3. In selection method 1-3, the base station eNB transmits, to the user equipment UE, group information in which the predetermined parameter is associated with the group (S31) and transmits, to the user equipment UE, access method instruction information in which the access method is associated with each group (S32). The base station eNB may broadcast the group information and the access method instruction information to the user equipments UE in a cell, using broadcast information, or may transmits, to the individual user equipment UE, the group information and the access method instruction information, using the signaling message (for example, an RRC message or DCI) of the individual user equipment UE which is used in a control channel. In addition, the base station eNB may broadcast the group information (or the access method instruction information), using the broadcast information, and may transmit the access method instruction information (or the group information), using the signaling message for the individual user equipment UE.

Then, the user equipment UE compares the group information with the predetermined parameter recognized (or selected) by the user equipment UE to determine the group including the user equipment UE (S33). Then, the user equipment UE compares the group including the user equipment UE with the access method instruction information to select an access method that is associated with the group including the user equipment UE (S34) and communicates with the base station eNB, using the selected access method (S35).

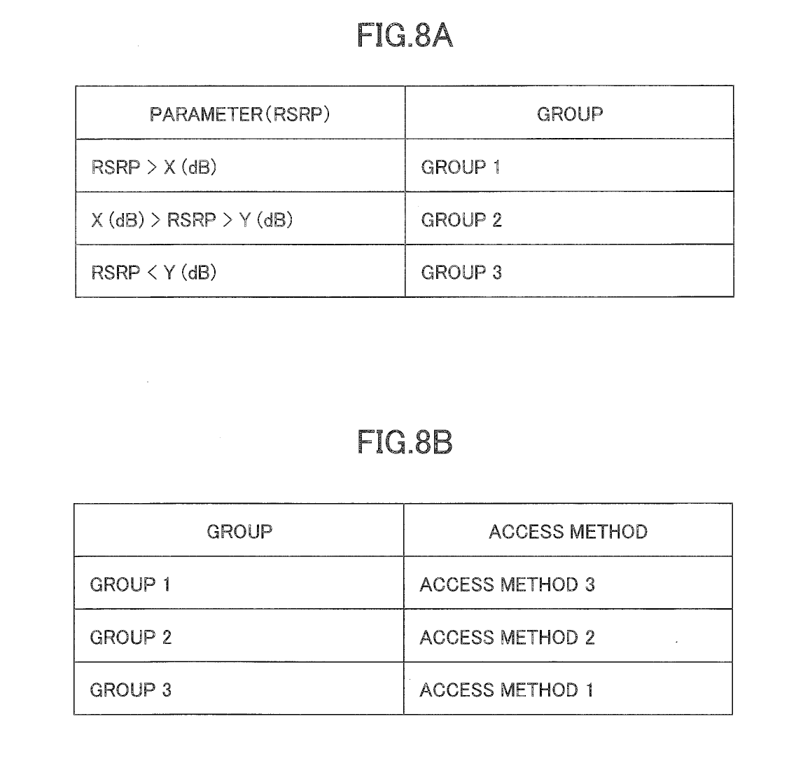

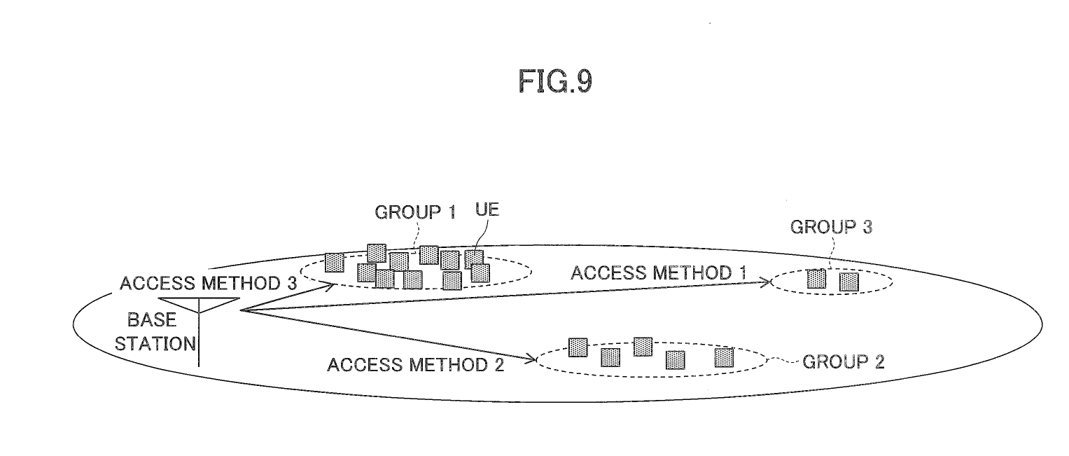

FIG. 8A illustrates an example of the group information and FIG. 8B illustrates an example of the access method instruction information in selection method 1-3. In the examples illustrated in FIGS. 8A and 8B, for example, the user equipment UE having a measured RSRP of X (dB) to Y (dB) communicates with the base station eNB using access method 2. FIG. 9 illustrates an example of the operation of the wireless communication system when access method selection method 1-3 is used. In the example illustrated in FIG. 9, a user equipment UE that is far away from the base station eNB belongs to group 3 and performs communication using access method 1. In addition, a user equipment UE that is close to the base station eNB belongs to group 1 and performs communication using access method 3.

In selection method 1-3, the base station eNB updates the access method instruction information to arbitrarily change the association between the groups and the access methods.

(Selection Method 2-1)

In selection method 2-1, the user equipment UE autonomously determines an access method and tries to communicate with the base station eNB. When the user equipment UE is unable to receive a response from the base station eNB, it changes the access method to another access method and tries to communicate with the base station eNB.

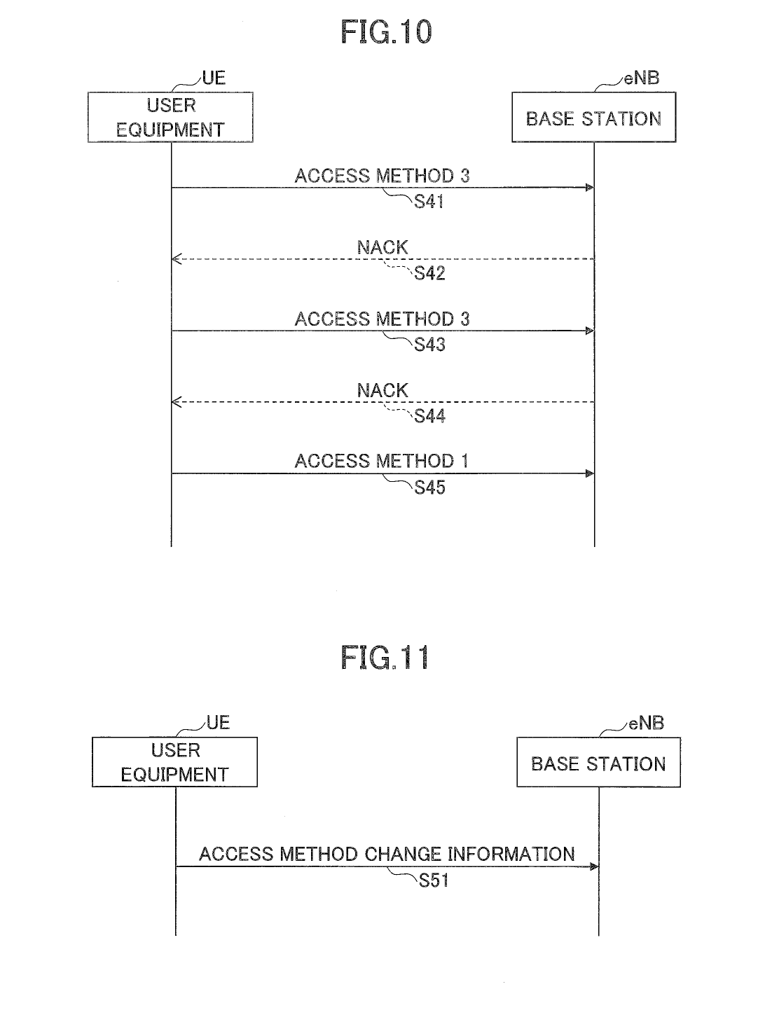

FIG. 10 is a sequence diagram illustrating the procedure of access method selection method 2-1. First, the user equipment UE tries to access the base station eNB, using access method 3 (S41). When the user equipment UE is unable to receive a response signal from the base station eNB (or when NACK is explicitly transmitted from the base station eNB) (S42), the user equipment UE transmits a UL signal to the base station eNB again, using access method 3 (S43). When the user equipment UE is unable to receive a response signal from the base station eNB (or when NACK is explicitly transmitted from the base station eNB) (S44), the user equipment UE transmits a UL signal to the base station eNB, using access method 1 (S45).

In FIG. 10, when access using access method 3 has failed two times, the user equipment UE uses access method 1. However, this is just an example. The user equipment UE may change the access methods in any order. For example, the user equipment UE may change the access methods such that access method 3 is used in a first transmission operation, access method 2 is used in a second transmission operation, and access method 1 is used in a third transmission operation. In addition, the user equipment UE may change the access methods such that access method 1 is used in the first transmission operation, access method 2 is used in the second transmission operation, and access method 3 is used in the third transmission operation.

(Selection Method 2-2)

In selection method 2-1, the user equipment UE autonomously changes the access methods. However, in selection method 2-2, the base station eNB transmits, to the user equipment UE, access method change information indicating the order in which the access methods are changed.

FIG. 11 is a sequence diagram illustrating the procedure of access method selection method 2-2. The base station eNB transmits, to the user equipment UE, the access method change information (S51). The base station eNB may broadcast the access method change information to the user equipments UE in a cell, using broadcast information, or may transmit, to the individual user equipment UE, the access method change information, using the signaling message (for example, an RRC message or DCI) for the individual user equipment UE which is used in a control channel.

<Radio Resources for Each Access Method>

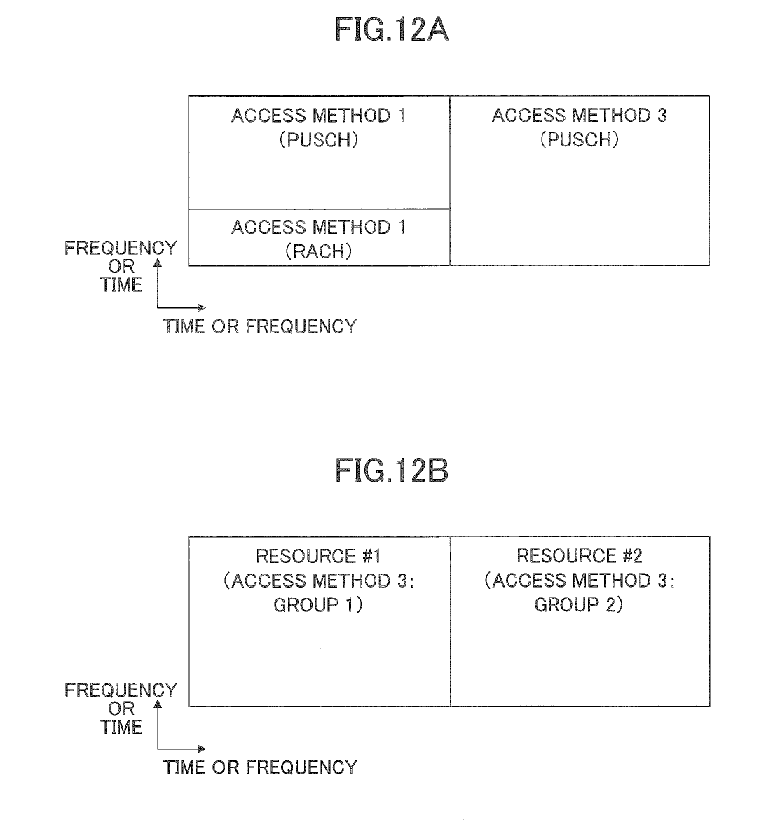

In this embodiment, specific radio resources may be allocated to each access method. For example, as illustrated in FIG. 12A, the radio resources used when a procedure corresponding to the random access procedure in LTE in access method 1 is performed, the radio resources used when data transmission is performed using the connection established between the base station eNB and the user equipment by access method 1, the radio resources used when data is transmitted to the base station eNB in access method 3 may be divided in a frequency direction or (and) a time direction.

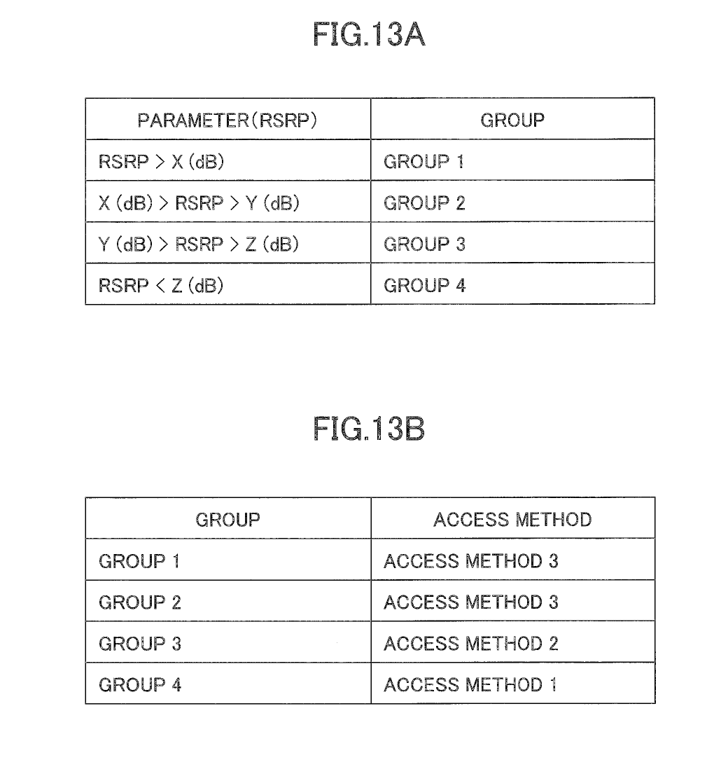

When the above-mentioned access method selection method 1-3 is used, for example, a plurality of groups may be allocated to the same access method, using group information illustrated in FIG. 13A and access method instruction information illustrated in FIG. 13B and different radio resources may be allocated to the groups using the same access method. For example, as illustrated in FIG. 12B, a resource (resource #1) which is used by the user equipment UE in group 1 using access method 3 and a resource (resource #2) which is used by the user equipment UE in group 2 using access method 3 may be divided in the frequency direction or (and) the time direction.

The base station eNB may broadcast the position of the radio resources allocated to each access method to the user equipments UE in a cell, using the broadcast information, or transmit, to the individual user equipment UE, the position, using the signaling message (for example, an RRC message or DCI) for the individual user equipment UE which is used in a control channel.

<Functional Structure>

An example of the functional structure of the user equipment UE and the base station eNB which perform the operations according to the plurality of embodiments will be described.

(User Equipment)

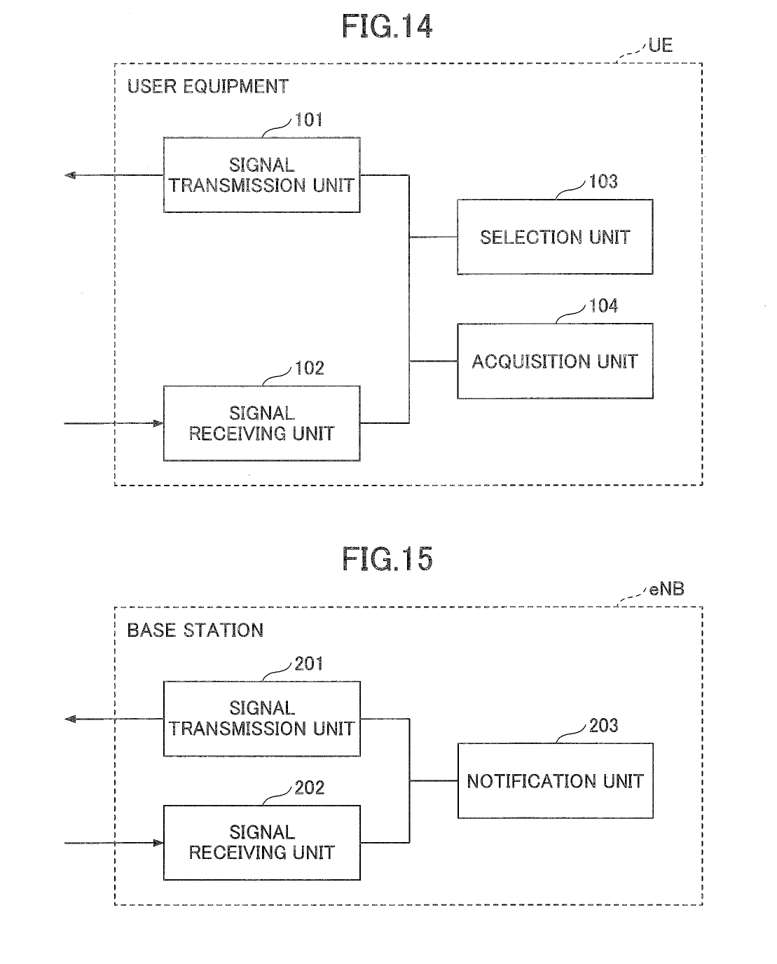

FIG. 14 is a diagram illustrating an example of the functional structure of the user equipment according to the embodiment. As illustrated in FIG. 14, the user equipment UE includes a signal transmission unit 101, a signal receiving unit 102, a selection unit 103, and an acquisition unit 104. FIG. 14 illustrates only the functional units of the user equipment UE which are particularly related to the embodiment of the invention and the user equipment UE has at least a function (not illustrated) for performing the operation based on LTE. The functional structure illustrated in FIG. 14 is just an example. The functional units may be classified in any way or may have any names as long as they can perform the operations related to this embodiment. However, some (for example, only one specific modification and embodiment or a plurality of modifications and embodiments) of the above-mentioned processes of the user equipment UE may be performed.

The signal transmission unit 101 has a function of generating various signals in a physical layer from signals in a higher layer which will be transmitted from the user equipment UE and wirelessly transmitting the generated signals. In addition, the signal transmission unit 101 has a function of transmitting an uplink signal to the base station eNB according to the procedure that is defined by the access method selected by the selection unit 103. When transmitting an uplink signal to the base station eNB according to the procedure that is defined by the access method selected by the selection unit 103, the signal transmission unit 101 may transmit the uplink signal, using the radio resources that are defined for the access method selected by the selection unit 103 in advance.

The signal receiving unit 102 has a function of wirelessly receiving various signals from other user equipments UE or the base station eNB and acquiring signals in the higher layer from the received signals in the physical layer. In addition, the signal receiving unit 102 has a function of receiving a response to the uplink signal, which has been transmitted from the signal transmission unit 101 according to the access method selected by the selection unit 103, from the base station eNB.

The selection unit 103 has a function of selecting one access method from a plurality of access methods used when uplink communications start. In addition, the selection unit 103 may compare the access method instruction information with a predetermined parameter recognized by the user equipment UE to select one access method. The selection unit 103 may compare the group information with a predetermined parameter recognized by the user equipment UE to determine the group including the user equipment UE and may compare the group including the user equipment with the access method instruction information to select one access method. When the signal receiving unit 102 does not receive a response to the uplink signal, which has been transmitted according to the procedure defined by the selected access method, from the base station eNB, the selection unit 103 may select another access method different from the selected access method.

The acquisition unit 104 has a function of acquiring the access method instruction information from the base station eNB. In addition, the acquisition unit 104 has a function of acquiring the group information and the access method instruction information from the base station eNB. The acquisition unit 104 further includes a function of acquiring the access method change information from the base station eNB.

(Base Station)

FIG. 15 is a diagram illustrating an example of the functional structure of the base station according to the embodiment. As illustrated in FIG. 15, the base station eNB includes a signal transmission unit 201, a signal receiving unit 202, and a notification unit 203. FIG. 15 illustrates only the functional units of the base station eNB which are particularly related to the embodiment of the invention and the base station eNB has at least a function (not illustrated) for performing the operation based on LTE. The functional structure illustrated in FIG. 15 is just an example. The functional units may be classified in any way or may have any names as long as they can perform the operations related to this embodiment. However, some (for example, only one specific modification and embodiment or a plurality of modifications and embodiments) of the above-mentioned processes of the base station eNB may be performed.

The signal transmission unit 201 has a function of generating various signals in the physical layer from signals in the higher layer which will be transmitted from the base station eNB and wirelessly transmitting the generated signals. The signal receiving unit 202 has a function of wirelessly receiving various signals from the user equipment UE and acquiring signals in the higher layer from the received signals in the physical layer.

The notification unit 203 has a function of transmitting, to the user equipment UE, the access method instruction information, the group information or/and the access method change information.

The entire functional structure of each of the user equipment UE and the base station eNB may be implemented by a hardware circuit (for example, one or a plurality of IC chips). Alternatively, a portion of the functional structure may be implemented by a hardware circuit and the other portion of the functional structure may be implemented by a CPU and a program.

(User Equipment)

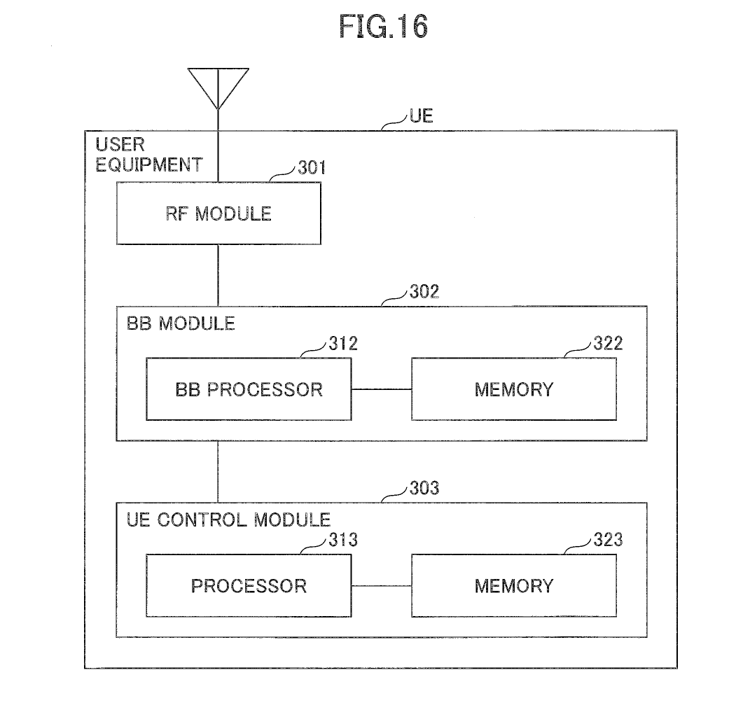

FIG. 16 is a diagram illustrating an example of the hardware configuration of the user equipment according to the embodiment. FIG. 16 illustrates a structure that is closer to an implementation example than that illustrated in FIG. 14. As illustrated in FIG. 16, the user equipment UE includes a radio frequency (RF) module 301 that performs a process related to radio signals, a base band (BB) processing module 302 that processes base band signals, and a UE control module 303 that processes, for example, the higher layer.

The RF module 301 performs, for example, digital-to-analog (D/A) conversion, modulation, frequency conversion, and power amplification for the digital base band signal received from the BB processing module 302 to generate a radio signal to be transmitted from an antenna. In addition, the RF module 301 performs, for example, frequency conversion, analog-to-digital (A/D) conversion, and demodulation for a received radio signal to generate a digital base band signal and transmits the digital base band signal to the BB processing module 302. The RF module 301 includes, for example, a portion of the signal transmission unit 101 and the signal receiving unit 102 illustrated in FIG. 14.

The BB processing module 302 performs a conversion process between an IP packet and a digital base band signal. A digital signal processor (DSP) 312 is a processor that performs signal processing in the BB processing module 302. A memory 322 is used as a work area of the DSP 312. The RF module 301 includes, for example, a portion of the signal transmission unit 101, a portion of the signal receiving unit 102, the selection unit 103, and the acquisition unit 104 illustrated in FIG. 14.

The UE control module 303 performs, for example, IP layer protocol processing and various kinds of application processing. A processor 313 performs the processes performed by the UE control module 303. A memory 323 is used as a work area of the processor 313. The UE control module 303 may include the acquisition unit 104 illustrated in FIG. 14.

(Base Station)

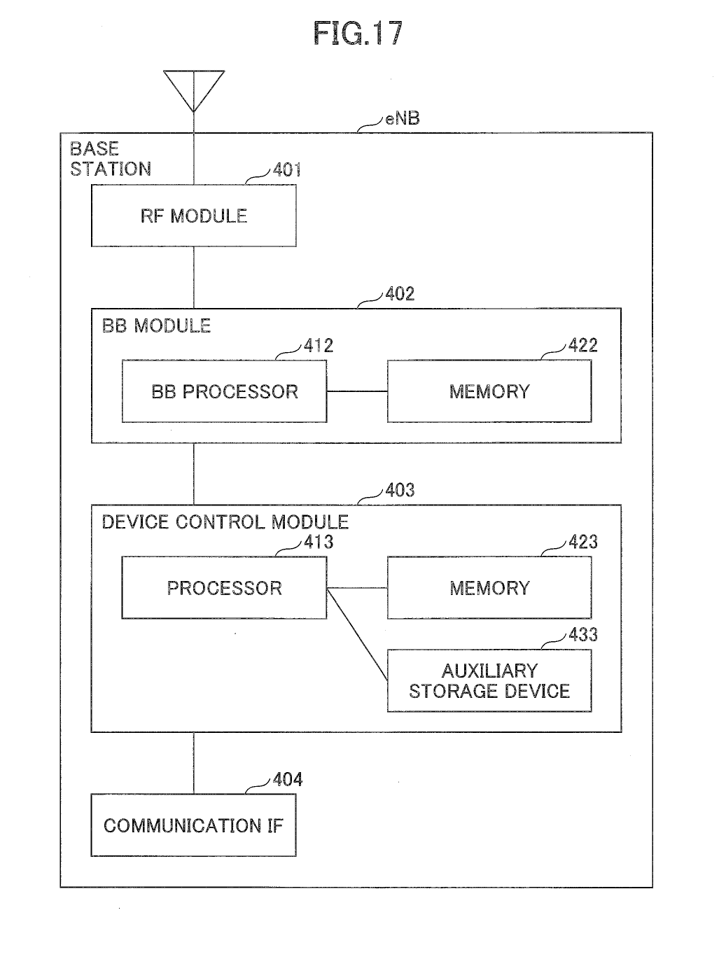

FIG. 17 is a diagram illustrating an example of the hardware configuration of the base station according to the embodiment. FIG. 17 illustrates a structure that is closer to an implementation example than that illustrated in FIG. 15. As illustrated in FIG. 17, the base station eNB includes an RF module 401 that performs a process related to radio signals, a BB processing module 402 that processes base band signals, a device control module 403 that processes, for example, a higher layer, and a communication IF 404 that is an interface for connection to the network.

The RF module 401 performs, for example, D/A conversion, modulation, frequency conversion, and power amplification for the digital base band signal received from the BB processing module 402 to generate a radio signal to be transmitted from an antenna. In addition, the RF module 401 performs, for example, frequency conversion, A/D conversion, and demodulation for a received radio signal to generate a digital base band signal and transmits the digital base band signal to the BB processing module 402. The RF module 401 includes, for example, a portion of the signal transmission unit 201 and the signal receiving unit 202 illustrated in FIG. 15.

The BB processing module 402 performs a conversion process between an IP packet and a digital base band signal. A DSP 412 is a processor that performs signal processing in the BB processing module 402. A memory 422 is used as a work area of the DSP 412. The BB processing module 402 includes, for example, a portion of the signal transmission unit 201, a portion of the signal receiving unit 202, and the notification unit 203 illustrated in FIG. 15.

The device control module 403 performs, for example, IP layer protocol processing and an operation and maintenance (OAM) process. A processor 413 performs the processes performed by the UE control module 403. A memory 423 is used as a work area of the processor 413. An auxiliary storage device 433 is, for example, an HDD and stores various kinds of setting information used for the operation of the base station eNB. The device control module 403 may include, for example, the notification unit 203 illustrated in FIG. 15.

<Summary>

According to an embodiment, there is provided a user equipment that is provided in a wireless communication system including a base station and the user equipment. The user equipment includes a selection unit that selects one access method from a plurality of access methods used when uplink communications start and a communication unit that transmits an uplink signal to the base station according to a procedure defined by the selected access method. A technique that can adaptively change various access methods is provided by the user equipment UE.

The user equipment may further include an acquisition unit that acquires access method instruction information in which a predetermined parameter and the access method are associated with each other from the base station. The selection unit may compare the acquired access method instruction information with the predetermined parameter recognized by the user equipment to select the one access method. According to this structure, it is possible adaptively change the access methods according to a parameter, such as signal reception quality or a modulation method.

The user equipment may further include an acquisition unit that acquires group information in which a predetermined parameter and a group are associated with each other and access method instruction information in which the access method is associated with each group from the base station. The selection unit may compare the acquired group information with the predetermined parameter recognized by the user equipment to determine a group including the user equipment and may compare the group including the user equipment with the access method instruction information to select the one access method. According to this structure, it is possible adaptively change the access methods according to a parameter, such as signal reception quality or a modulation method.

When the communication unit does not receive a response to the uplink signal, which has been transmitted according to the procedure defined by the selected access method, from the base station, the selection unit may select another access method different from the selected access method and the communication unit may transmit the uplink signal to the base station according to a procedure defined by another access method. According to this structure, the user equipment UE can adaptively change the access method.

The user equipment may further include an acquisition unit that acquires, from the base station, access method change information indicating an access method to be selected first and an access method to be selected when a response to the uplink signal transmitted according to the selected access method cannot be received from the base station among the plurality of access methods. The selection unit may select the access methods according to an order indicated by the access method change information. According to this structure, the base station eNB can instruct the order of the access methods that the user equipment UE tries to perform.

When transmitting the uplink signal to the base station according to the procedure defined by the selected access method, the communication unit may transmit the uplink signal, using radio resources which are defined for the selected access method in advance. According to this structure, it is possible to divide the radio resources for each access method and to effectively use the radio resources.

According to another embodiment, there is provided a communication method that is performed by a user equipment in a wireless communication system including a base station and the user equipment. The communication method includes a step of selecting one access method from a plurality of access methods used when uplink communications start and a step of transmitting an uplink signal to the base station according to a procedure defined by the selected access method. A technique that can adaptively change various access methods is provided by the communication method.

<Supplementary Explanation of Embodiment>

The structure of each device (the user equipment UE/the base station eNB) described in the embodiment of the invention may be implemented by the execution of a program by the CPU (processor) in the device including the CPU and the memory, may be implemented by hardware, such as a hardware circuit including a logic for the processes described in this embodiment, or may be implemented by a combination of the program and the hardware.

The embodiment of the invention has been described above. However, the disclosed invention is not limited to the embodiment and it will be understood by those skilled in the art that various variations, modifications, alterations, and substitutions can be made. Specific numerical examples are used to facilitate the understanding of the invention. However, the numerical values are just examples and any appropriate values may be used, unless otherwise noted. The classification of the items in the above-mentioned description is not essential in the invention and matters described in two or more items may be combined and used, if necessary. Matters described in an item may be applied to matters described in another item (as long as they do not contradict each other). The boundaries between the functional units or the processing units in the functional block diagram do not necessarily correspond to the boundaries between physical components. The operation of a plurality of functional units may be physically performed by one component. Alternatively, the operation of one functional unit may be physically performed by a plurality of components. In the sequences and the flowcharts described in the embodiment, the order of the processes may be changed as long as there is no contradiction between the processes. For convenience of explanation of the processes, the user equipment UE and the base station eNB have been described, using the functional block diagrams. However, the devices may be implemented by hardware, software, or a combination thereof. The software that is operated by the processor included in the user equipment UE according to the embodiment of the invention and the software that is operated by the processor included in the base station eNB according to the embodiment of the invention may be stored in any proper storage media, such as a random access memory (RAM), a flash memory, a read only memory (ROM), an EPROM, an EEPROM, a register, a hard disk (HDD), a removable disk, a CD-ROM, a database, and a server.

Information transmission (notification, reporting) may be performed not only by methods described in an aspect/embodiment of the present specification but also a method other than those described in an aspect/embodiment of the present specification. For example, the information transmission may be performed by physical layer signaling (e.g., DCI (Downlink Control Information), UCI (Uplink Control Information)), upper layer signaling (e.g., RRC signaling, MAC signaling, broadcast information (MIS (Master Information Block), SIB (System Information Block))), other signals, or combinations thereof. Further, an RRC message may be referred to as RRC signaling. Further, an RRC message may be, for example, an RRC connection setup message, an RRC connection reconfiguration message, or the like.

An aspect/embodiment described in the present specification may be applied to a system that uses LTE (Long Term Evolution), LTE-A (LTE-Advanced), SUPER 3G, IMT-Advanced, 4G, 5G, FRA (Future Radio Access), W-CDMA (registered trademark), GSM (registered trademark), CDMA2000, UMB (Ultra Mobile Broadband), IEEE 802.11 (Wi-Fi), IEEE 802.16 (WiMAX), IEEE 802.20, UWB (Ultra-WideBand), Bluetooth (registered trademark), other appropriate systems, and/or a next generation system enhanced based thereon.

Determination or judgment may be performed according to a value (0 or 1) represented by a bit, may be performed according to a boolean value (true or false), or may be performed according to comparison of numerical values (e.g., comparison with a predetermined value).

It should be noted that the terms described in the present specification and/or terms necessary for understanding the present specification may be replaced by terms that have the same or similar meaning. For example, a channel and/or a symbol may be a signal. Further, a signal may be a message.

There is a case in which a UE may be referred to as a subscriber station, a mobile unit, subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other appropriate terms.

An aspect/embodiment described in the present specification may be used independently, may be used in combination, or may be used by switching according to operations. Further, transmission of predetermined information (e.g., transmission of “it is X”) is not limited to explicitly-performed transmission. The transmission of predetermined information may be performed implicitly (e.g., explicit transmission of predetermined information is not performed).

As used herein, the term “determining” may encompasses a wide variety of actions. For example, “determining” may be regarded as calculating, computing, processing, deriving, investigating, looking up (e.g., looking up in a table, a database or another data structure), ascertaining and the like. Also, “determining” may be regarded as receiving (e.g., receiving information), transmitting (e.g., transmitting information), inputting, outputting, accessing (e.g., accessing data in a memory) and the like. Also, “determining” may be regarded as resolving, selecting, choosing, establishing, comparing and the like. That is, “determining” may be regarded as a certain type of action related to determining.

As used herein, the phrase “based on” does not mean, unless otherwise noted, “based on only”. In other words, the phrase “base on” means both “based on only” and “based on at least”.

Also, the order of processing steps, sequences or the like of an aspect/embodiment described in the present specification may be changed as long as there is no contradiction. For example, in a method described in the present specification, elements of various steps are presented in an exemplary order. The order is not limited to the presented specific order.

Input/output information, etc., may be stored in a specific place (e.g., memory) or may be stored in a management table. The input/output information, etc., may be overwritten, updated, or added. Output information, etc., may be deleted. Input information, etc., may be transmitted to another apparatus.

Transmission of predetermined information (e.g., transmission of “it is X”) is not limited to explicitly-performed transmission. The transmission of predetermined information may be performed implicitly (e.g., explicit transmission of predetermined information is not performed).

Information, a signal, etc., described in the present specification may be represented by using any one of the various different techniques. For example, data, an instruction, a command, information, a signal, a bit, a symbol, a chip or the like described throughout in the present specification may be represented by voltage, current, electromagnetic waves, magnetic fields or a magnetic particle, optical fields or a photon, or any combination thereof.

The present invention is not limited to the above embodiments and various variations, modifications, alternatives, replacements, etc., may be included in the present invention without departing from the spirit of the invention.

The present application is based on and claims the benefit of priority of Japanese Priority Application No. 2016-073460 filed on Mar. 31, 2016, the entire contents of which are hereby incorporated by reference.

### EXPLANATIONS OF LETTERS OR NUMERALS

UE USER EQUIPMENT
eNB BASE STATION
101 SIGNAL TRANSMISSION UNIT
102 SIGNAL RECEIVING UNIT
103 SELECTION UNIT
104 ACQUISITION UNIT
201 SIGNAL TRANSMISSION UNIT
202 SIGNAL RECEIVING UNIT
203 NOTIFICATION UNIT
301 RF MODULE
302 BB PROCESSING MODULE
303 UE CONTROL MODULE
304 COMMUNICATION IF
401 RF MODULE
402 BB PROCESSING MODULE
403 DEVICE CONTROL MODULE

1. A user equipment that is provided in a wireless communication system including a base station and the user equipment, the user equipment comprising:
a selection unit that selects one access method from a plurality of access methods used when uplink communications start; and
a communication unit that transmits an uplink signal to the base station according to a procedure defined by the selected access method.

2. The user equipment according to claim 1, further comprising:
an acquisition unit that acquires access method instruction information in which a predetermined parameter is associated with the access methods from the base station,
wherein the selection unit selects the one access method by comparing the acquired access method instruction information with the predetermined parameter recognized by the user equipment.

3. The user equipment according to claim 1, further comprising:
an acquisition unit that acquires group information in which a predetermined parameter is associated with groups and access method instruction information in which the access methods are associated with the groups from the base station,
wherein the selection unit determines a group to which the user equipment belongs by comparing the acquired group information with the predetermined parameter recognized by the user equipment, and selects the one access method by comparing the group to which the user equipment belongs with the access method instruction information.

4. The user equipment according to claim 1,
wherein, when the communication unit does not receive a response to the uplink signal, which has been transmitted according to the procedure defined by the selected access method, from the base station, the selection unit selects another access method different from the selected access method, and
the communication unit transmits the uplink signal to the base station according to a procedure defined by the another access method.

5. The user equipment according to claim 4, further comprising:
an acquisition unit that acquires, from the base station, access method change information indicating an access method to be selected first and an access method to be selected when a response to the uplink signal transmitted according to the selected access method cannot be received from the base station among the plurality of access methods, and
the selection unit selects the access methods according to an order indicated by the access method change information.

6. The user equipment according to claim 1,
wherein, when transmitting the uplink signal to the base station according to the procedure defined by the selected access method, the communication unit transmits the uplink signal, using radio resources which are defined for the selected access method in advance.

7. A communication method that is performed by a user equipment in a wireless communication system including a base station and the user equipment, the communication method comprising:
a step of selecting one access method from a plurality of access methods used when uplink communications start; and
a step of transmitting an uplink signal to the base station according to a procedure defined by the selected access method.

8. The user equipment according to claim 2,
wherein, when transmitting the uplink signal to the base station according to the procedure defined by the selected access method, the communication unit transmits the uplink signal, using radio resources which are defined for the selected access method in advance.

9. The user equipment according to claim 3,
wherein, when transmitting the uplink signal to the base station according to the procedure defined by the selected access method, the communication unit transmits the uplink signal, using radio resources which are defined for the selected access method in advance.

10. The user equipment according to claim 4,
wherein, when transmitting the uplink signal to the base station according to the procedure defined by the selected access method, the communication unit transmits the uplink signal, using radio resources which are defined for the selected access method in advance.

11. The user equipment according to claim 5,
wherein, when transmitting the uplink signal to the base station according to the procedure defined by the selected access method, the communication unit transmits the uplink signal, using radio resources which are defined for the selected access method in advance.
